(19) United States
(12) Patent Application Publication
(10) Pub. No.: US 2017/0173765 A1
(43) Pub. Date: Jun. 22, 2017

(54) COMBINATIVE CONNECTOR

(71) Applicant: Yih Cheng Factory Co., Ltd, Taichung (TW)

(72) Inventor: Jack Lin, Taichung (TW)

(21) Appl. No.: 14/973,569

(22) Filed: Dec. 17, 2015

(51) Int. Cl. B25B 23/00

(52) U.S. Cl. CPC B25B 23/0035

(57) ABSTRACT

A combinative connector includes a connecting rod and a socket. The connecting rod sequentially includes a polygonal insert, a circular portion, a conical frustum and an external annular groove. The socket sequentially includes a polygonal bore, a circular bore, an internal annular groove and an annular flange. During insertion of the polygonal insert in the polygonal bore, the conical frustum is moved past the annular flange before the circular portion is inserted in the circular bore, the conical frustum is inserted in the internal annular groove and engaged with the annular flange, and the annular flange is inserted in the external annular groove. A gap between the circular portion and a wall of the circular bore is smaller than a gap between the polygonal insert and a wall of the polygonal bore to reduce rocking of the connecting rod relative to the socket.

### BACKGROUND OF INVENTION

1. Field of Invention

The present invention relates to an apparatus for connecting a tool to a bit and, more particularly, to combinative connector for connecting a tool to a bit.

2. Related Prior Art

A conventional tool such as a one-way wrench, a pneumatic tool and an electric tool includes an operative end to be inserted in a socket which in turn receives an object to be rotated such as a screw. In some working environments, it is desired to use an elongated connector to extend the distance between the operative end and the socket or the object to be rotated.

A conventional connector includes a square insert to be inserted in a square bore made in the socket. Thus, torque can be transferred to the socket from the tool via the connector. Generally, the square insert is provided with a spring-biased ball to abut against the wall of the square bore to keep the socket on the connector in operation. However, the socket could be disengaged from the connector if subject to a force larger than the force of friction between the spring-biased ball and the wall of the square bore. Moreover, the gap between the surface of the square insert and the wall of the square bore there is big enough for the socket to rock relative to the connector. Hence, time required to fasten the object to be rotated is increased, the efficiency of the operation is reduced, and the risks of damaging the socket or injuring a user are increased.

The present invention is therefore intended to obviate or at least alleviate the problems encountered in prior art.

### SUMMARY OF INVENTION

It is the primary objective of the present invention to provide an efficient, effective, reliable and safe combinative connector.

To achieve the foregoing objective, the combinative connector includes a connecting rod and a socket. The connecting rod sequentially includes a polygonal insert, a circular portion, a conical frustum and an external annular groove. The socket sequentially includes a polygonal bore, a circular bore, an internal annular groove and an annular flange. During insertion of the polygonal insert in the polygonal bore, the conical frustum is moved past the annular flange before the circular portion is inserted in the circular bore, the conical frustum is inserted in the internal annular groove and engaged with the annular flange, and the annular flange is inserted in the external annular groove. A gap between the circular portion and a wall of the circular bore is smaller than a gap between the polygonal insert and a wall of the polygonal bore to reduce rocking of the connecting rod relative to the socket.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is a side view of a combinative connector according to the preferred embodiment of the present invention;

FIG. 2 is a left side view of the combinative connector illustrated in FIG. 1;

FIG. 3 is a right side view of the combinative connector shown in FIG. 1;

FIG. 4 is an enlarged partial view of a connecting rod of the combinative connector shown in FIG. 1;

FIG. 5 is an enlarged cross-sectional view of a connecting rod of the combinative connector shown in FIG. 1;

FIG. 6 is an enlarged cross-sectional partial view of the combinative connector shown in FIG. 1; and

FIG. 7 is an enlarged partial view of the combinative connector shown in FIG. 6.

### DETAILED DESCRIPTION OF PREFERRED EMBODIMENT

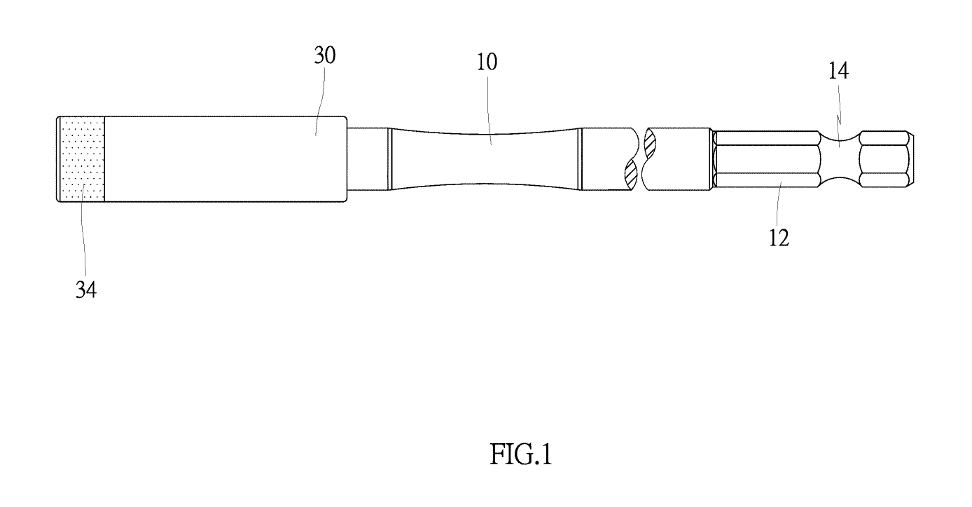

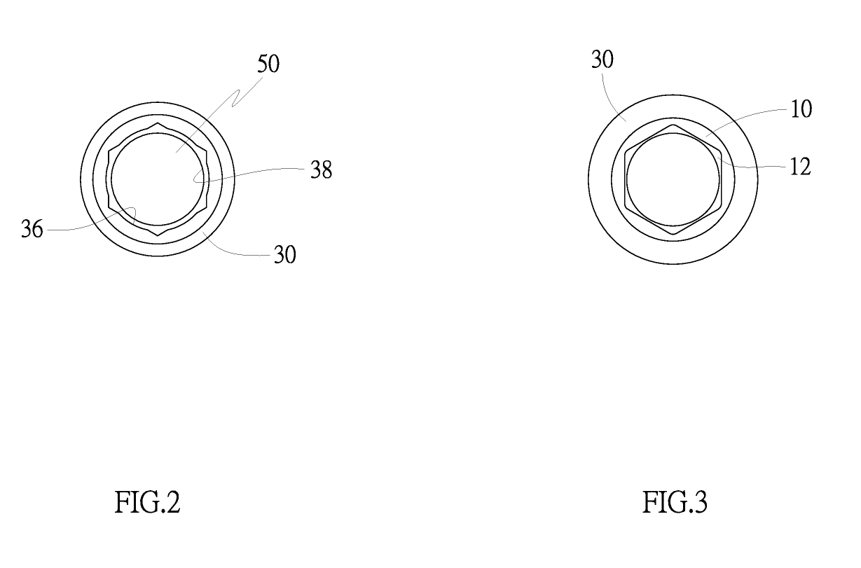

Referring to FIGS. 1 through 3, a combinative connector includes a connecting rod 10, a socket 30 and a magnetic device 50 according to the preferred embodiment of the present invention.

The socket 30 includes a circular periphery coated with an annular band of electroplate 34. The socket 30 includes a first end located near the annular band of electroplate 34 and a second end located far from the annular band of electroplate 34.

The first end of the socket 30 is made with a polygonal bore 36 and a circular bore 38. The polygonal bore 36 is preferably a hexagonal bore in communication with the polygonal bore 36. The circular bore 38 is located deeper than the polygonal bore 36.

The second end of the socket 30 is made with a polygonal bore 37 and an engagement device 40. The second end of the socket 30 is adapted to receive a compliant portion of the connecting rod 10. The polygonal bore 37 is preferably a hexagonal bore. The engagement device 40 is provided in or on the wall of the polygonal bore 37.

The polygonal bore 37 is separated from the polygonal bore 36 in the preferred embodiment. However, the polygonal bore 37 can be in communication with the polygonal bore 36 in an alternative embodiment.

The magnetic device 50 can be a permanent magnet. The magnetic device 50 is moved past the polygonal bore 36 before it is fitted in the circular bore 38. The magnetic device 50 is adapted for attracting a bit such as a screwdriver (not shown) inserted in the polygonal bore 36.

The annular band of electroplate 34 is made of chromium or any other proper type of metal. By electroplating, the annular band of electroplate 34 is provided on the socket 30 for aesthetic and protective purposes. The color of the annular band of electroplate 34 is different from that of the other portions of the socket 30.

In some embodiments, the socket 30 includes an identification unit (not numbered). The identification unit can be a trademark for example. The color of the trademark is different from that of the other portions of the socket 30. Hence, the trademark is highly recognizable and useful in letting a user know the manufacturer of the combinative connector. The identification unit can alternatively be a symbol or number. The color of the symbol or number is different from that of the other portions of the socket 30. Hence, the symbol or number is highly recognizable and useful in letting the user know the size and system of unit of the combinative connector.

The connecting rod 10 includes a first end located out of the socket 30 and a second end inserted in the socket 30. The first end of the connecting rod 10 is formed with a polygonal insert 12. The polygonal insert 12 is a hexagonal insert. The polygonal insert 12 is adapted for insertion in an electric or pneumatic tool (not shown) so that the polygonal insert 12 is rotated by the electric or pneumatic tool. Hence, torque is transferred to the socket 30 from the electric or pneumatic tool via the connecting rod 10. An annular groove 14 is made in a middle portion of the connecting rod 10. The annular groove 14 is adapted for receiving a compliant portion of the electric or pneumatic tool so that the connecting rod 10 and the socket 30 are kept on the electric or pneumatic tool.

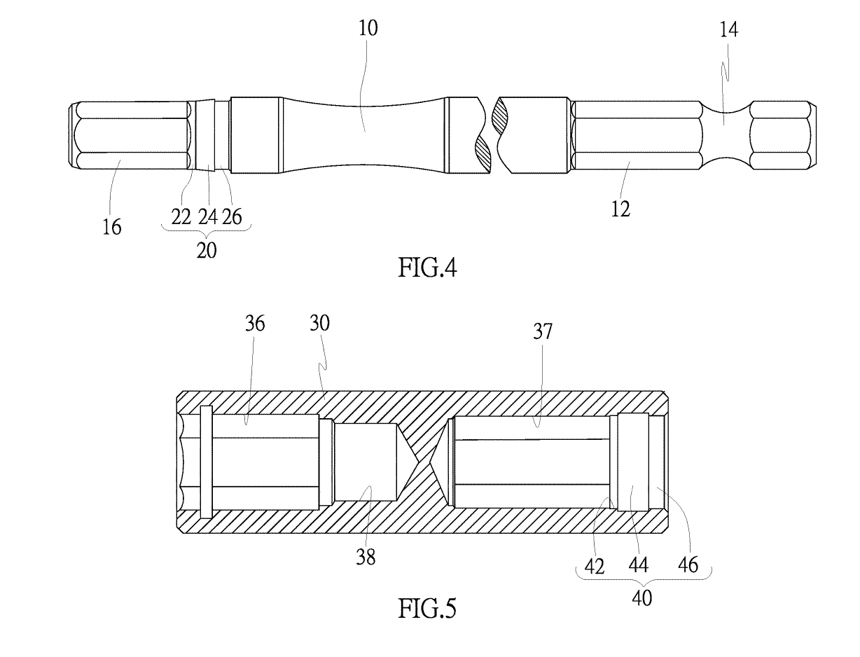

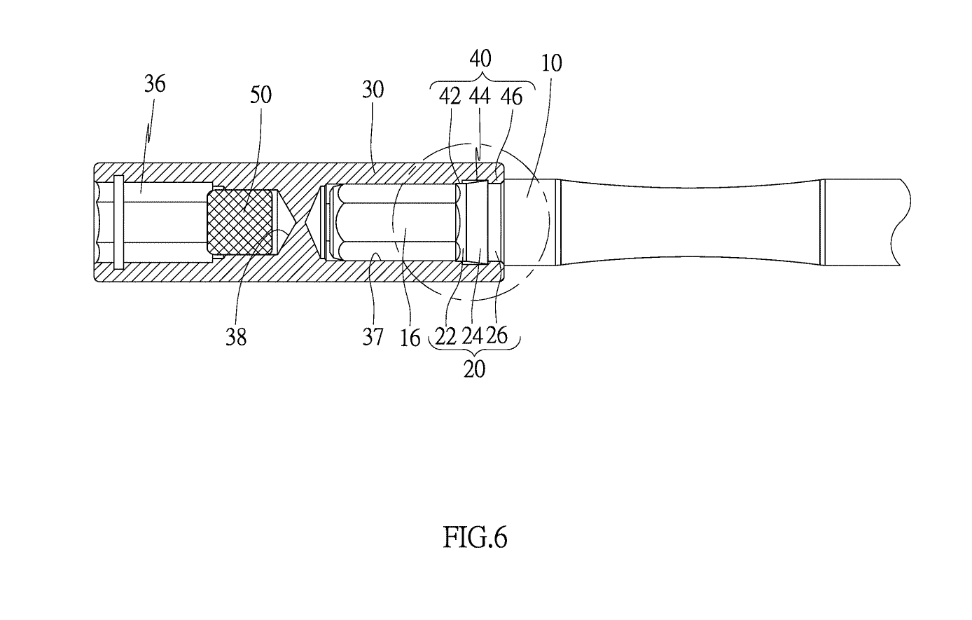

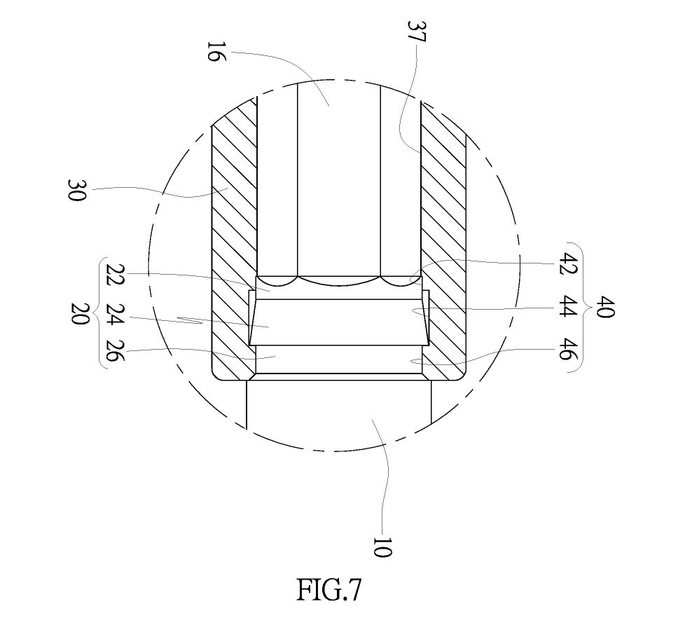

Referring to FIGS. 4 to 7, the connection of the connecting rod 10 to the socket 30 will be described in detail. The connecting rod 10 includes a polygonal insert 16 and an engagement device 20. The polygonal insert 16 and the polygonal insert 12 are located on different ends of the connecting rod 10. The polygonal insert 16 is also a hexagonal insert. The engagement device 20 is located near the polygonal insert 16.

The engagement device 20 is engaged with the engagement device 40 as the polygonal insert 16 is inserted in the polygonal bore 37 of the socket 30. Therefore, the connection of the connecting rod 10 to the socket 30 is retained. Now, the periphery of the polygonal insert 16 is engaged with the wall of the polygonal bore 37 of the socket 30 so that they cannot be rotated relative to each other, i.e., the connecting rod 10 rotates the socket 30 to transfer the torque from the electric or pneumatic tool.

In an alternative embodiment, the polygonal insert 16 is a square insert or in any other proper non-circular shape. Accordingly, the polygonal bore 37 is a square bore or in any other proper non-circular shape.

In detail, the engagement device 20 includes a circular portion 22, a conical frustum 24 and an external annular groove 26. The diameter of the circular portion 22 is identical to that of the floor of the external annular groove 26. The diameter of the circular portion 22 is marginally larger than the length of a diagonal line of the polygonal insert 16. The conical frustum 24 is formed between the circular portion 22 and the external annular groove 26. The conical frustum 24 includes a small end located next to the circular portion 22 and a large end located next to the external annular groove 26.

In the polygonal bore 37, the socket 30 includes a circular bore 42, an internal annular groove 44 and an annular flange 46. The bore 42 is located deeper than the internal annular groove 44, which is located deeper than the annular flange 46. The engagement device 40 consists of the circular bore 42, the internal annular groove 44 and the annular flange 46. The diameter of the circular bore 42 is marginally larger than the length of a diagonal line of the polygonal bore 37. The polygonal bore 37 is in communication with the internal annular groove 44 via the circular bore 42. The annular flange 46 includes an inclined annular face at the second end of the socket 30.

To bring the engagement devices 20 and 40 into engagement with each other, the conical frustum 24 is smoothly moved on and then past the inclined annular face of the annular flange 46 before the annular flange 46 is inserted in the external annular groove 26. The annular flange 46 is made with an axial length identical to an axial width of the external annular groove 26 so that an annular face of the former is in contact with an annular face of the latter. Now, the circular portion 22 is inserted in the circular bore 42. The gap between the circular portion 22 and the wall of the circular bore 42 is smaller than the gap between the polygonal insert 16 and the polygonal bore 37 so that there is little rocking of socket 30 relative to the connecting rod 10. Hence, the operation of the combinative connector is stable.

The present invention has been described via detailed illustration of the preferred embodiment. Those skilled in the art can derive variations from the preferred embodiment without departing from the scope of the present invention. Therefore, the preferred embodiment shall not limit the scope of the present invention defined in the claims.

1. A combinative connector comprising:
a connecting rod sequentially comprising a polygonal insert, a circular portion, a conical frustum and an external annular groove;
a socket sequentially comprising a first polygonal bore, a circular bore, an internal annular groove and an annular flange, wherein during insertion of the polygonal insert in the first polygonal bore, the conical frustum is moved past the annular flange before the circular portion is inserted in the circular bore, the conical frustum is inserted in the internal annular groove and engaged with the annular flange, and the annular flange is inserted in the external annular groove, wherein a gap between the circular portion and a wall of the circular bore is smaller than a gap between the polygonal insert and a wall of the first polygonal bore to reduce rocking of the connecting rod relative to the socket.

2. The combinative connector according to claim 1, wherein the socket further comprises a second polygonal bore located opposite to the first polygonal bore.

3. The combinative connector according to claim 2, further comprising a magnetic device inserted in the first polygonal bore.

4. The combinative connector according to claim 1, wherein the conical frustum comprises a small end next to the circular portion and a large end next to the external annular groove.

5. The combinative connector according to claim 1, wherein the circular portion is made with a diameter larger than the length of a diagonal line of the polygonal insert, wherein the circular bore is made with a diameter larger than the length of a diagonal line of the second polygonal bore to render the gap between the circular portion and the wall of the circular bore smaller than the gap between the polygonal insert and the wall of the first polygonal bore.

6. The combinative connector according to claim 1, wherein the socket comprises an annular band of electroplate provided thereon.
